(19) United States
(12) Patent Application Publication
(10) Pub. No.: US 2017/0261707 A1
(43) Pub. Date: Sep. 14, 2017

(54) OPTICAL RECEIVER AND OPTICAL TRANSCEIVER

(71) Applicant: FUJITSU LIMITED, Kawasaki-shi (JP)

(72) Inventor: Miki ONAKA, Kawasaki (JP)

(73) Assignee: FUJITSU LIMITED, Kawasaki-shi (JP)

(21) Appl. No.: 15/423,077

(22) Filed: Feb. 2, 2017

(30) Foreign Application Priority Data
Mar. 11, 2016 (JP) 2016-048148

(51) Int. Cl. G02B 6/42; H04B 10/60; H04B 10/40; G02B 6/293; G02B 6/43

(52) U.S. Cl. CPC G02B 6/4246; G02B 6/4215; G02B 6/4206; G02B 6/4295; G02B 6/29361; G02B 6/43; H04B 10/40; H04B 10/60

(57) ABSTRACT

In an optical receiver, a first optical filter (one of a long-pass optical filter and a short-pass optical filter) is provided on an optical incident surface of a light collection device. A second optical filter (the other one of the long-pass optical filter and the short-pass optical filter) is provided on an optical reception surface of a light reception device.

### CROSS-REFERENCE TO RELATED APPLICATION

This application is based upon and claims the benefit of priority of the prior Japanese Patent Application No. 2016-048148, filed on Mar. 11, 2016, the entire contents of which are incorporated herein by reference.

### FIELD

The embodiment discussed herein is related to an optical receiver and an optical transceiver.

### BACKGROUND

There are known optical transceivers supporting bi-directional optical communication by commonly using one optical fiber for transmission and reception.

In some cases, the optical transceiver supporting bi-directional optical communication may be referred to as a bi-directional optical sub-assembly (BOSA).

For example, the BOSA may be applied to an optical network unit (ONU) of a passive optical network (PON) system.

### Related Art Document List

Patent Document 1: JP 63-70207 A

Patent Document 2: JP 1-188806 A

Patent Document 3: JP 2009-200448 A

In order to miniaturize an ONU, optical transceivers applied to the ONU which employ a form called a small form-factor pluggable (SFP) have been studied. In an SFP dedicated to a transceiver for data communication network, the dimensions, pin arrangement, and the like have been standardized by a multi-source agreement (MSA).

By applying the SFP form to the optical transceiver, it is expected that the volume of the ONU may be reduced by about 1/60 in comparison with an existing ONU.

However, when trying to apply the SFP form to the optical transceiver, there may occur a spatial limitation (sometimes, referred to as “limitation in a mount space”) in sizes of optical parts or number of parts which are mountable in the optical transceiver.

Due to the limitation in the mount space, in some cases, it is not possible to mount optical parts which are to be inevitably provided to the optical transceiver (for example, a reception system) in the state of the existing spatial arrangement or sizes.

When the arrangement intervals between the optical parts are too reduced in the state of the existing sizes in the mount space having the limitation, production yield of the optical transceiver may be decreased, or aging deterioration may easily occur due to contact for reducing interval margin between the optical parts.

### SUMMARY

According to an aspect, an optical receiver may include: a light collection device; light reception device arranged to receive output light of the light collection device; a first optical filter provided on an optical incident surface of the light collection device; and a second optical filter provided on an optical reception surface of the light reception device. One of the first and second optical filters may be a long-pass optical filter, and the other one of the first and second optical filters may be a short-pass optical filter.

In the aspect, the optical transceiver may include an optical transmitter, a wavelength separation device, and an optical receiver. The optical transmitter may transmit first light. The wavelength separation device may transmit the first light to an optical fiber transmission line and reflect second light toward a direction intersecting with a direction in which the first light propagates, the second light having a wavelength different from that of the first light and propagating in the optical fiber transmission line in a direction reverse to the direction in which the first light propagates. The optical receiver may receive the second light reflected by the wavelength separation device. The optical receiver may include: a light collection device on which the second light is incident; a light reception device configured to receive output light of the light collection device; a first optical filter provided on an optical incident surface of the light collection device; and a second optical filter provided on an optical reception surface of the light reception device. One of the first and second optical filters may be a long-pass optical filter, and the other one of the first and second optical filters may be a short-pass optical filter.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of configuration of an optical transceiver according to an embodiment;

FIG. 2 is a block diagram illustrating an example of configuration of an optical receiver illustrated in FIG. 1;

FIG. 3A is a diagram illustrating an example of a filter characteristic of a long-pass optical filter;

FIG. 3B is a diagram illustrating an example of a filter characteristic of a short-pass optical filter;

FIG. 4 is a diagram illustrating an example of a filter characteristic of a band pass optical filter obtained by combining filter characteristic illustrated in FIGS. 3A and 3B;

FIG. 5 is a diagram illustrating an example of wavelength arrangement in a passive optical network (PON) system;

FIG. 6 is a diagram illustrating an example of wavelength arrangement in a PON system;

FIG. 7 is a diagram illustrating an example where cut-off amounts of cut-off bands are different between a long-pass optical filter and a short-pass optical filter;

FIG. 8 is a diagram illustrating an example where cut-off amounts of cut-off bands are different between a long-pass optical filter and a short-pass optical filter;

FIGS. 9A to 9D are diagram illustrating a relationship between an optical filter using a dielectric multi-layer film and a filter characteristic and thickness of the optical filter;

FIG. 10A is a diagram illustrating that, although a dielectric multi-layer film for a long-pass optical filter and a dielectric multi-layer film for a short-pass optical filter are adhered to each other by using adhesive, an expected filter characteristic of a band pass optical filter is not obtainable;

FIG. 10B is a diagram illustrating that, although a dielectric multi-layer film for a long-pass optical filter and a dielectric multi-layer film for a short-pass optical filter are laminated on a substrate, an expected filter characteristic of a band pass optical filter is not obtainable;

FIGS. 11A and 11B are diagrams illustrating an example where a convex lens portion of a plano-convex lens illustrated in FIG. 2 has a spherical shape;

FIGS. 12A and 12B are diagrams illustrating an example where the convex lens portion of the plano-convex lens illustrated in FIG. 2 has an aspherical shape;

FIG. 13 is a block diagram illustrating that a distance (D) between a center of optical axis in the optical transceiver illustrated in FIG. 1 and an edge surface of the optical receiver may be reduced;

FIG. 14 is a block diagram illustrating Comparative Example for explaining a reason why a distance (D) illustrated in FIG. 13 may be reduced;

FIG. 15 is a block diagram illustrating that it is not possible to reduce the distance (D) illustrated in FIG. 13 although a filter characteristic of a band pass optical filter is implemented by combining individual parts of a long-pass optical filter and a short-pass optical filter;

FIGS. 16 and 17 are block diagrams illustrating modified examples of Comparative Example illustrated in FIG. 14;

FIG. 18 is a diagram illustrating an example of a manufacturing method for a plano-convex lens attached with an optical filter illustrated in FIG. 2;

FIG. 19 is a diagram illustrating an example of a manufacturing method for a light reception device attached with an optical filter illustrated in FIG. 2;

FIG. 20 is a schematic side cross-sectional view illustrating an example of a structure of a light reception device attached with an optical filter illustrated in FIG. 2;

FIG. 21 is a schematic side cross-sectional view illustrating a first modified example of FIG. 20; and

FIG. 22 is a schematic side cross-sectional view illustrating a second modified example of FIG. 20.

### DESCRIPTION OF EMBODIMENTS

Hereinafter, an exemplary embodiment(s) will be described with reference to the drawings. However, the embodiment(s) described below is merely an example and not intended to exclude an application of various modifications or techniques which are not explicitly described below. Further, various exemplary aspects described below may be appropriately combined and carried out. Elements or components assigned the same reference numeral in the drawings used for the following embodiment(s) will represent identical or similar elements or components unless otherwise specified.

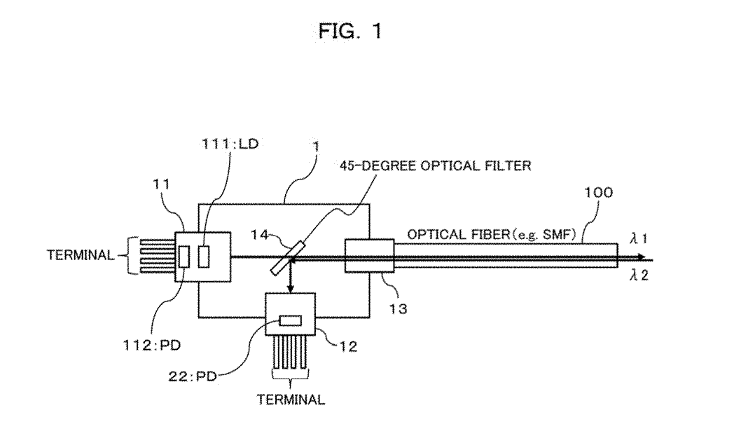

FIG. 1 is a block diagram illustrating an example of configuration of an optical transceiver according to an embodiment. An optical transceiver 1 illustrated in FIG. 1 may be referred to as a “single-core bi-directional optical transceiver”, an “SFP optical transceiver”, or a “BOSA”.

The SFP optical transceiver 1 is an example of an optical transceiver employing a SFP form where a size, pin arrangement, and the like are regulated according to an industrial standard called MSA, as described above. The SFP optical transceiver 1 has been popularized because of small size, low price, and easiness to handle.

The optical transceiver 1 illustrated in FIG. 1 may be used for an ONU or an optical line terminal (OLT) in a PON system, for example. As the PON system, there may also be a system being referred to as a “GE-PON” system as a fusion of a PON technique and a Gigabit Ethernet (GE) technique. The “Ethernet” is a registered trademark.

The ONU corresponds to, for example, an optical line terminal device installed in a subscriber's house in a subscriber network (which may be a public network) using an optical fiber transmission line. The OLT corresponds to, for example, an optical line terminal device installed in a station building of a communication service provider.

For example, the ONU is an apparatus performing mutual conversion or the like between an optical signal and an electric signal and is configured to include a port (or a connector) for connection of an optical fiber and a data communication port for connection to a computer or a computer network such as a local area network (LAN). An example of the data communication port is a communication port for Ethernet, a communication port for wireless LAN, and other like.

As the ONU, there is also an ONU having a function of a switching hub (or, a LAN switch) capable of being connected to a plurality of computers or a function as a broadband router having an internet connection function or the like. In the ONU, there is no need to separately prepare a switching hub or a router in a subscriber's house.

As illustrated in FIG. 1, the optical transceiver 1 according to the embodiment may be configured to include an optical transmitter 11, an optical receiver 12, an optical fiber connector 13, and a 45-degree incident light filter 14, for example. The “45-degree incident light filter 14” may be abbreviated with a “45-degree optical filter 14”.

The optical transmitter 11 transmits light having a wavelength λ1. The light having the wavelength λ1 is an example of the first light. The wavelength λ1 of the light transmitted by the optical transmitter 11 may be referred to as a “transmission wavelength λ1”.

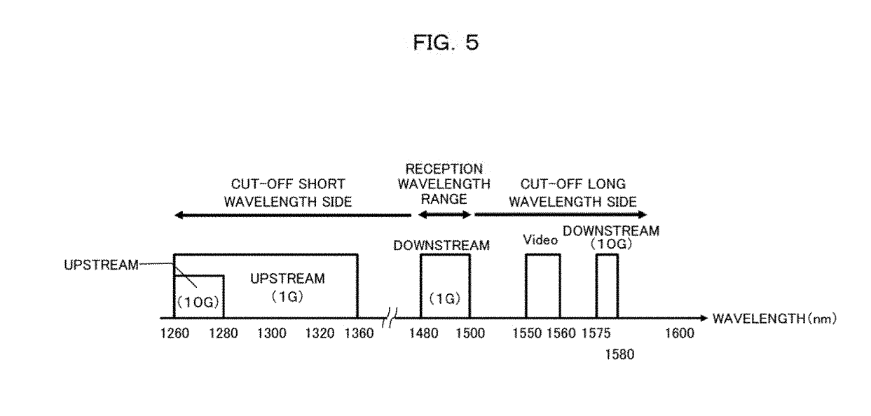

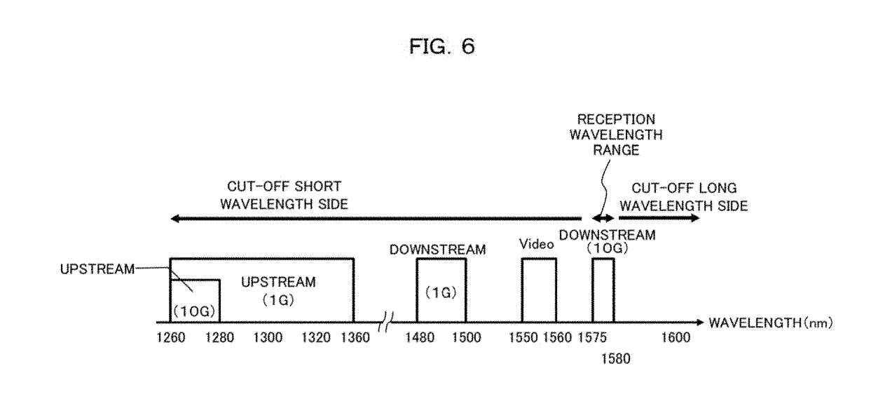

As a non-limitative example, as illustrated in FIGS. 5 and 6, the transmission wavelength λ1 may correspond to a wavelength in 1.31 μm band for 1-Gbps (gigabit per second) class upstream transmission or a wavelength in 1.27 μm band for 10-Gbps-class upstream transmission in the PON system.

In the PON system, the “upstream” direction is a direction from the ONU to the OLT.

The optical transmitter 11 may be configured to include, for example, a light source 111 which outputs the light having the transmission wavelength λ1 and a light reception device 112. A semiconductor laser diode (LD) may be applied to the light source 111, for example. A PD may be applied to the light reception device 112, for example. The “PD” is an alleviation of a photodiode or a photodetector.

The light having the transmission wavelength λ1 output from the LD 111 passes through the 45-degree optical filter 14 and is guided to an optical fiber 100 connected to the optical fiber connector 13. A ferrule may be applied to the optical fiber connector 13, for example.

The optical fiber 100 may be a single mode optical fiber (SMF) or may be a portion of an optical fiber transmission line in a PON system, for example.

The PD 112 receives a portion of the light output by the LD 111 and may be used to monitor whether or not the output wavelength of the LD 111 becomes an expected transmission wavelength λ1. Therefore, the PD 112 may also be referred to as a “monitor PD 112” for descriptive purposes. However, the monitor PD 112 may be an optional component in the optical transmitter 11.

Meanwhile, the optical receiver 12 receives light having a wavelength λ2 different from the transmission wavelength λ1. The light having the wavelength λ2 is an example of the second light. For example, the wavelength λ2 may be a wavelength satisfying λ2>λ1. However, the magnitude relationship between the wavelengths λ1 and λ2 may be reverse to the above-described magnitude relationship. For descriptive purposes, the wavelength λ2 of the light received by the optical receiver 12 may be referred to as a “reception wavelength λ2”.

The light having the reception wavelength λ2 is transmitted in the direction opposite to that of the transmission wavelength λ1 in the optical fiber 100 in which the light having the transmission wavelength λ1 is transmitted. In the PON system, the transmission wavelength λ1 corresponds to the “upstream” direction, and the reception wavelength λ2 corresponds to the “downstream” direction from the OLT to the ONU.

As a non-limitative example, as described later in FIGS. 5 and 6, the reception wavelength λ2 may correspond to wavelength in 1.49 μm band for 1-Gbps-class downstream transmission or wavelength of 1.75 μm band for 10-Gbps-class downstream transmission in the PON system.

As illustrated in FIG. 1, the optical receiver 12 may include a light reception device 22. For example, a PD may be applied to the light reception device 22.

Both of the optical transmitter 11 and the optical receiver 12 described above may be configured as a package optical module referred to as “CAN”. For example, an optical transmitter 11 having a CAN configuration may be referred to as TO-CAN for transmission, and an optical receiver 12 having a CAN configuration may be referred to as TO-CAN for reception. The “TO” is an alleviation of a “transistor outlined”.

For example, the 45-degree optical filter 14 has a filter characteristic where light having the transmission wavelength λ1 which is incident on one surface (first surface) with an incident angle of 45 degrees passes through a second surface opposite to the first surface and light having the reception wavelength λ2 which is incident on the second surface with an incident angle of 45 degrees is reflected.

Therefore, the light having the transmission wavelength λ1 passes through the 45-degree optical filter 14 to be output to the optical fiber 100, and the light having the reception wavelength λ2 which propagates from the optical fiber 100 in the reverse direction to be output is reflected on the reflection surface of the 45-degree optical filter 14 to be output toward the optical receiver 12.

Since the optical receiver 12 is arranged in a direction (for example, a direction perpendicular to the direction) intersecting with the direction where the light having the transmission wavelength λ1 propagates, the 45-degree optical filter 14 guides the light having the reception wavelength λ2 in the direction intersecting with the direction where the light having the transmission wavelength λ1 propagates.

In other words, the 45-degree optical filter 14 is commonly used for the transmission light having the wavelength λ1 and the reception light having the wavelength λ2 and may spatially separate the transmission light having the wavelength λ1 and the reception light having the wavelength λ2. Therefore, the 45-degree optical filter 14 is an example of a wavelength separation device which spatially separates the light having the wavelength λ1 and the light having the wavelength λ2.

The light having the reception wavelength λ2 which is reflected by the 45-degree optical filter 14 and is incident on the optical receiver 12 is received by the PD 22.

As illustrated in FIG. 1, the SFP optical transceiver 1 has a shape where the length in the propagation direction of the transmission light is longer than the length in the propagation direction of the reception light, and thus, as described above, the SFP optical transceiver guides the reception light in the transverse direction where the length is short (in other words, the width is small) and receives the light by the PD 22.

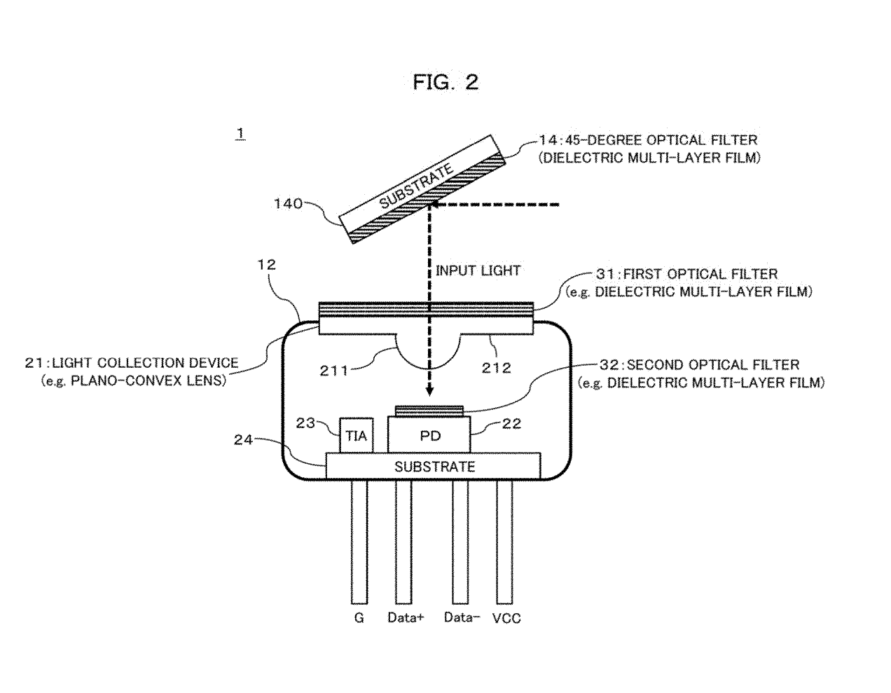

As illustrated in FIG. 2, the 45-degree optical filter 14 may be a dielectric multi-layer film which is formed on one surface of the substrate 140 through deposition or the like. For example, the substrate 140 may be a glass substrate using quartz glass.

(Example of Configuration of Optical Receiver 12)

Next, an example of the configuration of the above-described optical receiver 12 is illustrated in FIG. 2. FIG. 2 is a schematic side view illustrating an inner portion of the optical receiver 12 as viewed from the side surface in a perspective manner.

As illustrated in FIG. 2, the optical receiver 12 may be configured to include, for example, a light collection device 21, a light reception device 22, a first optical filter 31, and a second optical filter 32.

The optical filters 31 and 32 may be arranged at positions which are spatially different in an optical path where the input light passes through light collection device 21 and propagates toward the light reception device 22 in the optical receiver 12.

The light collection device 21 collects the input light on an optical reception surface of the light reception device 22. The input light of the light collection device 21 is, for example, light reflected by the 45-degree optical filter 14.

For example, a plano-convex lens may be applied to the light collection device 21. The plano-convex lens 21 has a plane surface at the side opposite to the side where the convex lens portion 211 is formed. The plane surface may be referred to as a “back surface” of the plano-convex lens 21, for descriptive purposes. The back surface of the plano-convex lens 21 corresponds to an optical incident surface of the light collection device 21.

In FIG. 2, reference numeral 212 denotes a stub (sometimes, referred to as a “flange”) of the convex lens portion 211. The size (area) of the stub 212 is arbitrary and it is possible that the stub is not provided to the plano-convex lens 21.

The plano-convex lens 21 may be provided to the optical receiver 12 so that the convex lens portion 211 faces the inner side of the space inside the optical receiver 12 and the back surface faces the outer side (for example, the 45-degree optical filter 14) of the optical receiver 12.

In other words, the relative arrangement relationship between the 45-degree optical filter 14 and the plano-convex lens 21 may be formed so that the light reflected by the 45-degree optical filter 14 is incident on the back surface of the plano-convex lens 21.

As illustrated in FIG. 2, the first optical filter 31 may be provided to the back surface of the plano-convex lens 21. For example, the first optical filter 31 may be a dielectric multi-layer film. The first dielectric multi-layer film 31 may be formed on the back surface of the plano-convex lens 21 through deposition, for example. In other words, the plano-convex lens 21 may be commonly used as the substrate of the dielectric multi-layer film 31.

The light reception device 22 may be provided on the substrate 24 to receive the light, which passes through the first optical filter 31 and is collected to the plano-convex lens 21 to be emitted, on the optical reception surface.

Besides the light reception device 22, electric parts or electric circuits such as a trans-impedance amp (TIA) 23 may be appropriately provided on the substrate 24. The TIA 23 converts a current signal according to light reception power of the light reception device 22 to a voltage signal.

As illustrated in FIG. 2, the second optical filter 32 may be provided on the optical reception surface of the light reception device 22. Similarly to the first optical filter 31, the second optical filter 32 may also be a dielectric multi-layer film. For example, the second dielectric multi-layer film 32 may be formed on the optical reception surface of the light reception device 22 through deposition. In other words, the light reception device 22 may be commonly used as the substrate of the dielectric multi-layer film 32.

Both of the first optical filter 31 and the second optical filter 32 may be single side band (SSB) filters. The SSB filter has a filter characteristic where light is transmitted or blocked only in one of the short wavelength side and the long wavelength side. For this reason, the SSB filter may be referred to as an “edge pass filter” or an “edge cut-off filter”. The “blocking” may be referred to as “attenuation”, “suppression”, or “reflection”.

Examples of the SSB filter are a long-pass optical filter and short-pass optical filter. For example, the long-pass optical filter has a filter characteristic where light having a wavelength longer than a cut-on wavelength is transmitted.

Since light having a short wavelength of the cut-on wavelength or less is blocked, the long-pass optical filter may be referred to as a “short (short wavelength) cut optical filter”. The “cut-on wavelength” may be understood to correspond to a wavelength where the optical filter just starts light transmission in the case where the wavelength is changed from a short wavelength to a long wavelength.

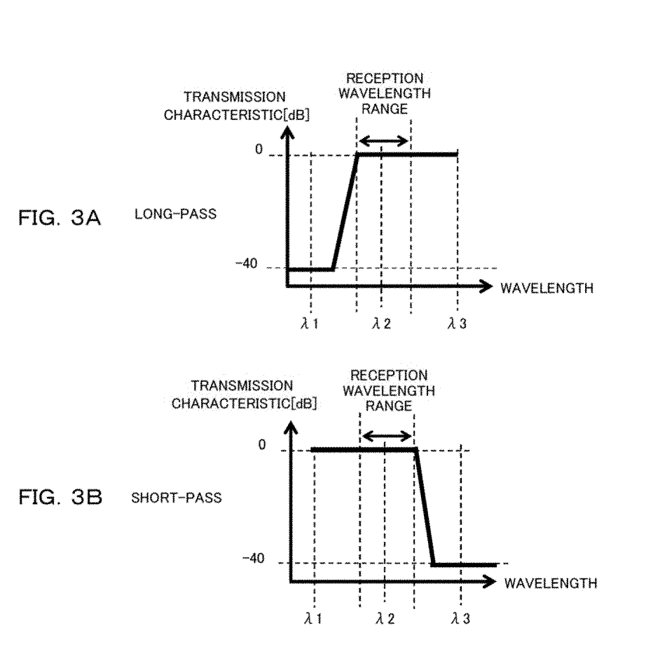

FIG. 3A illustrates an example of a transmission characteristic of the long-pass optical filter. As illustrated in FIG. 3A, the long-pass optical filter may have a cut-on wavelength λcut-on between the wavelength λ1 and the wavelength λ2 and may have a filter characteristic of transmitting light having the wavelength λ2 or λ3 longer than the cut-on wavelength λcut-on and reflecting and blocking light having the wavelength λ1 shorter than the cut-on wavelength λcut-on. In FIG. 3A, λ3>λ2.

As described above, the wavelengths λ1 and λ2 may correspond to the transmission wavelength λ1 and the reception wavelength λ2 of the optical transceiver 1, respectively. In some case, light having the wavelength λ3 may be used for transmission of video signals (in other words, video transmission) described later.

On the other hand, the short-pass optical filter has a filter characteristic where light having a wavelength shorter than a cut-off wavelength is transmitted, for example.

Since light having a long wavelength of the cut-off wavelength or more is blocked, the short-pass optical filter may be referred to as a “long (long wavelength) cut optical filter”. The “cut-off wavelength” may be understood to correspond to a wavelength where the optical filter just stops light transmission in the case where the wavelength is changed from a short wavelength to a long wavelength.

FIG. 3B illustrates an example of a transmission characteristic of the short-pass optical filter. As illustrated in FIG. 3B, the short-pass optical filter may has a cut-off wavelength λcut-off in the wavelength side longer than the wavelength λ2 between the wavelength λ2 and the wavelength λ3, for example.

In other words, the short-pass optical filter may have a filter characteristic where the light having the wavelengths λ1 and λ2 shorter than the cut-off wavelength λcut-off is transmitted and the light having the wavelength λ3 longer than the cut-off wavelength λcut-off is blocked.

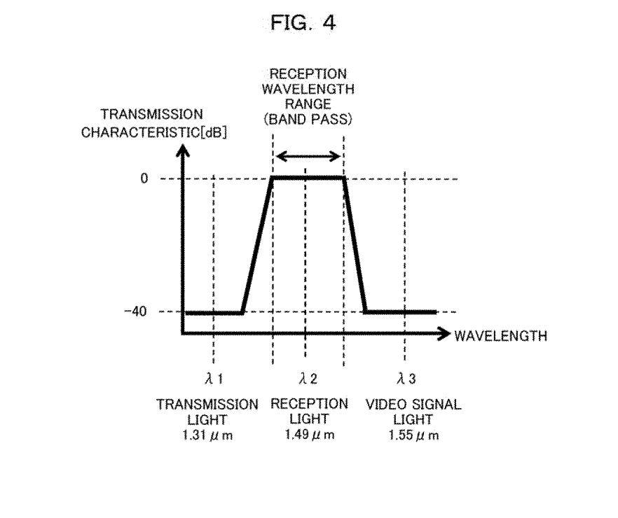

By combining the filter characteristic of the long-pass optical filter illustrated in FIG. 3A and the filter characteristic of the short-pass optical filter illustrated in FIG. 3B, the filter characteristic corresponding to the band pass optical filter illustrated in FIG. 4 can be obtained. In some cases, the filter characteristic corresponding to the band pass optical filter may be alleviated with a “BPF characteristic” for descriptive purposes.

The BPF characteristic is used in order to allow the optical receiver 12 to selectively receive the light having the wavelength λ2 which is desired to be received in the optical transceiver 1. Due to the BPF characteristic, the stray light component having a wavelength other than the wavelength λ2 which is desired to be received is blocked or suppressed, so that it may be possible to improve the reception characteristic (sometimes, referred to as “reception quality”) of the optical receiver 12. An example of an index of the reception quality is an optical signal-to-noise ratio (OSNR), a bit error rate (BER), or the like.

The BPF characteristic illustrated in FIG. 4 is a filter characteristic where the light having the reception wavelength λ2 is transmitted and the light having the transmission wavelength λ1 in the wavelength side shorter than the reception wavelength λ2 and the light having the wavelength λ3 in the wavelength side longer than the reception wavelength λ2 are reflected to be blocked.

As illustrated in FIG. 4, the pass band in the BPF characteristic corresponds to the reception wavelength range (in other words, the reception band) of the optical receiver 12. The pass band in the BPF characteristic may be set according to the reception wavelength range of the optical receiver 12.

For example, the relative arrangement relationship between the pass band in the BPF characteristic and the wavelengths λ1 to λ3 may be set so that the reception wavelength λ2 is included and the wavelengths λ1 and λ3 are not included in the reception wavelength range of the optical receiver 12.

One of the long-pass optical filter and the short-pass optical filter may be applied to one of the optical filters 31 and 32 illustrated in FIG. 2, and the other of the optical filters 31 and 32 may be applied to the other of the long-pass optical filter and the short-pass optical filter.

For example, in the configuration illustrated in FIG. 2, the first optical filter 31 provided to the plano-convex lens 21 may be set to a long-pass optical filter, and the second optical filter 32 provided to the light reception device 22 may be set to a short-pass optical filter.

On the contrary, the first optical filter 31 provided to the plano-convex lens 21 may be set to a short-pass optical filter, and the second optical filter 32 provided to the light reception device 22 may be set to a long-pass optical filter.

Next, a relationship between the above-described wavelengths λ1 to λ3 and the example of wavelength arrangement in the PON system will be described with reference to FIG. 5. FIG. 5 is a diagram illustrating an example of wavelength arrangement in the PON system.

As illustrated in FIG. 5, a wavelength in 1.31 μm band (for example, in a range of 1260 nm to 1360 nm) may be used for 1-Gbps-class upstream transmission, and a wavelength in 1.49 μm band (for example, in a range of 1480 nm to 1500 nm) may be used for 1-Gbps-class downstream transmission.

A wavelength in 1.27 μm band (for example, in a range of 1260 nm to 1280 nm) may be used for the 10-Gbps-class upstream transmission, and a wavelength in 1.57 μm band (for example, in a range of 1575 nm to 1580 nm) may be used for 10-Gbps-class downstream transmission. A wavelength of 1.55 μm band (for example, in a range of 1550 nm to 1560 nm) may be used for video transmission where video signal light is transmitted.

According to the example of wavelength arrangement of FIG. 5, in the PON system supporting 1-Gbps-class or 10-Gbps-class light transmission, video transmission service may be allowed to coexist.

Herein, in the example of wavelength arrangement of FIG. 5, if the above-described reception wavelength λ2 is set to a wavelength in 1.49 μm band for 1-Gbps-class downstream transmission, the wavelength λ1 illustrated in FIGS. 3 and 4 may be allowed to correspond to a wavelength in 1.31 μm band for 1-Gbps-class upstream transmission. Alternatively, the wavelength λ1 may be allowed to correspond to a wavelength in 1.27 μm band for 10-Gbps-class upstream transmission.

Therefore, according to the filter characteristics illustrated in FIGS. 3 and 4, in the optical transceiver 1 which shares the optical fiber 100 for transmission and reception, it may be possible to block or suppress the stray light components of the upstream transmission light in 1.31 μm band or 1.27 μm band of the wavelength side shorter than the reception wavelength λ2 of the downstream transmission light. The stray light component is an example of a noise component corresponding to the reception wavelength λ2.

On the other than, the wavelength λ3 illustrated in FIGS. 3 and 4 may correspond to the wavelength in 1.55 μm band for video transmission and the wavelength in 1.57 μm band for 10-Gbps-class downstream transmission in FIG. 5.

Therefore according to the filter characteristic illustrated in FIGS. 3 and 4, in the optical transceiver 1, it may be possible to block or suppress the stray light components of transmission light in 1.55 μm band or 1.57 μm band of the wavelength side longer than the reception wavelength λ2 of the downstream transmission light.

As another example, the reception wavelength λ2 in the optical transceiver 1 in the example of wavelength arrangement of FIG. 5 may be set to a wavelength in 1.57 μm band for 10-Gbps-class downstream transmission as illustrated in FIG. 6.

In this case, in the filter characteristic illustrated in FIGS. 3 and 4, the wavelength λ1 may correspond to several wavelengths for video transmission (1.55 μm band), 1-Gbps-class upstream transmission (1.31 μm band), and 10-Gbps-class upstream transmission (1.27 μm band).

Therefore, in the example of FIG. 6, it may be possible to block or suppress the stray light components having the wavelengths for video transmission, 1-Gbps-class downstream transmission, 1-Gbps-class upstream transmission, and 10-Gbps-class upstream transmission located in the wavelength side shorter than the reception wavelength λ2 (1.57 μm band) in the optical transceiver 1.

In the example of wavelength arrangement of FIG. 6, a wavelength which is to correspond to the wavelength λ3 illustrated in FIGS. 3 and 4 does not exist. If there exists light transmission using a wavelength in the wavelength side longer than a wavelength in 1.57 μm band for 10-Gbps-class upstream transmission, the wavelength may correspond to the wavelength λ3.

However, the BPF characteristic illustrated in FIG. 4 has symmetry where the equal cut-off amounts of the input light are blocked in the short wavelength side and the long wavelength side with respect to the wavelength λ2 as a center. The “cut-off amount” may be referred as an “attenuation amount” or a “reflection amount”.

However, the BPF characteristic obtained by combining the filter characteristics of the optical filters 31 and 32 illustrated in FIGS. 3A and 3B may be an asymmetric characteristic where the attenuation amounts are different between the short wavelength side and the long wavelength side with respect to the wavelength λ2 as a center.

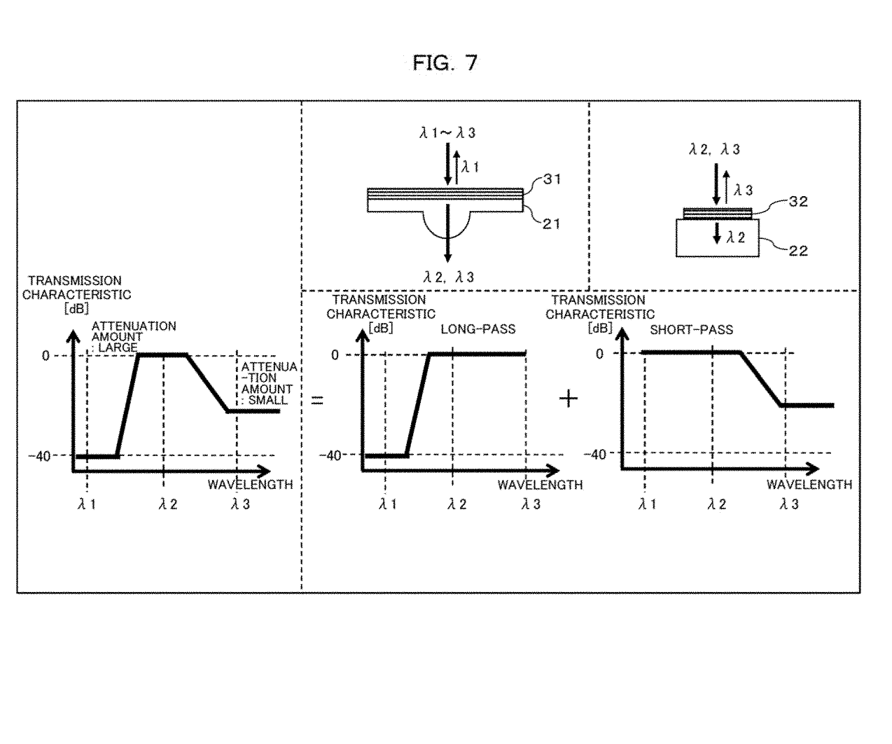

FIG. 7 illustrates an example of an asymmetric BPF characteristic obtained by combining the optical filters 31 and 32. FIG. 7 illustrates an example where the long-pass optical filter 31 has a cut-off amount (being a maximum value or a minimum value, this is similar hereinafter) of the cut-off band larger than that of the short-pass optical filter 32 as a non-limitative example. A difference between different cut-off amounts may be 3 dB or more, for example.

In the example of FIG. 7, the “cut-off band” may be understood to correspond to a wavelength band of which transmission amount [dB] is less than zero. The “cut-off band” may be referred to as an “attenuation band” or a “reflection band”.

In this case, the light having the wavelength λ1 located in the short wavelength side of the reception wavelength λ2 is greatly attenuated in comparison with the light having the wavelength λ3 located in the long wavelength side of the reception wavelength λ2. Therefore, the asymmetric BPF characteristic illustrated in FIG. 7 is useful for the case where the light having the wavelength λ1 is desired to be more greatly attenuated than the light having the wavelength λ3.

For example, it is assumed that, as illustrated in FIG. 6, the reception wavelength λ2 of the optical transceiver 1 is set to a wavelength in 1.57 μm band for 10-Gbps-class downstream transmission. In this case, the light having the wavelength λ1 in the 1.55 μm band for video transmission close to the short wavelength side of the wavelength λ2 may be greatly attenuated in comparison with the light having the wavelength λ3 located in the long wavelength side of the wavelength λ2.

Therefore, the stray light components of the video signal light for video transmission interfere with the reception light having the wavelength λ2, so that it may be effectively suppress or avoid a reduction in reception quality of the light having the wavelength λ2, that is, a reception target wavelength.

In the PON system, in some case, transmission power of the video signal light may be larger than that of other signal light. In this case, the stray light component of the video signal light having the wavelength λ1 may be mixed into the light having the reception wavelength λ2. Therefore, the effective suppression of the stray light components of the video signal light greatly contributes to improvement of the reception characteristic of the optical receiver 12.

As illustrated in FIG. 5, if it is assumed that the reception wavelength λ2 of the optical transceiver 1 is set to a wavelength in the 1.49 μm band, a wavelength in 1.55 μm band for video transmission corresponds to the wavelength λ3 in the wavelength side longer than the reception wavelength λ2.

In the wavelength side shorter than the reception wavelength λ2, located is a wavelength in 1.31 μm band for 1-Gbps-class upstream transmission or a wavelength in 1.27 μm band for 10-Gbps-class upstream transmission corresponding to the wavelength λ1.

In this case, to the reception wavelength λ2 in 1.49 μm band, a wavelength in 1.55 μm band for video transmission is closer than a wavelength in 1.31 μm band for 1-Gbps-class upstream transmission or a wavelength in 1.27 μm band for 10-Gbps-class upstream transmission.

For this reason, the stray light components having the wavelength in 1.55 μm band for video transmission λ3 may be more likely to interfere with the light having the reception wavelength λ2 and may be more likely to influence on the reception quality of the wavelength λ2 than the stray light components having the wavelength λ1 for 1-Gbps-class or 10-Gbps-class upstream transmission.

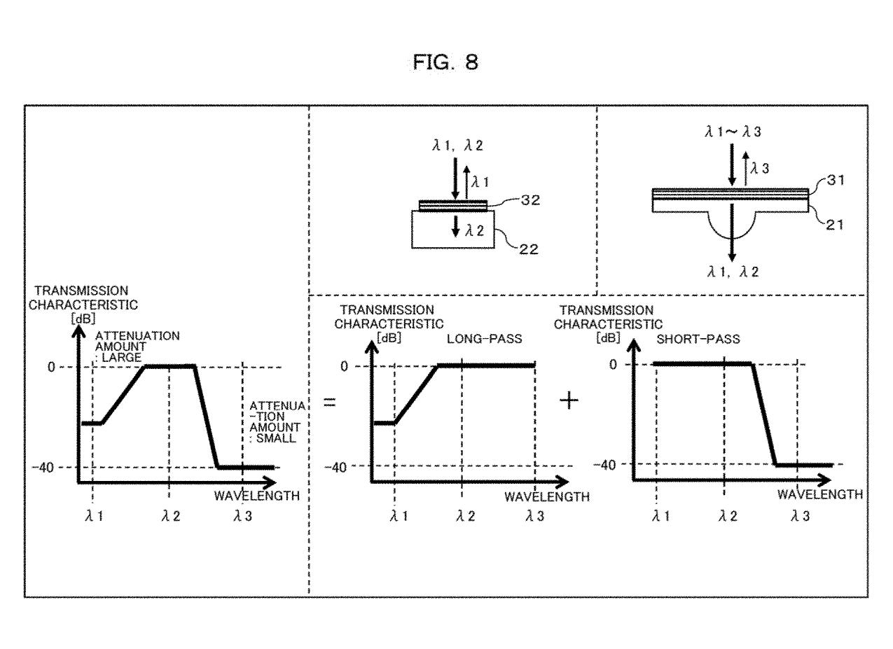

Therefore, in the case where the reception wavelength λ2 is set to a wavelength in 1.49 μm band for 1-Gbps-class downstream transmission, contrary to the example of FIG. 7, the attenuation amount in the attenuation band of the short-pass optical filter 32 may be set to be larger than that of the long-pass optical filter 31 (refer to FIG. 8).

In any example of FIGS. 7 and 8, one of the optical filters 31 and 32 having different cut-off amounts of the cut-off bands may be provided to one of the plano-convex lens 21 and the light reception device 22, and the other of the optical filters 31 and 32 may be provided to the other of the plano-convex lens 21 and the light reception device 22.

In some cases, it is preferable that among the optical filters 31 and 32, one optical filter having a cut-off amount larger than that of the other optical filter in the cut-off band is provided on the plano-convex lens 21, and the other optical filter having a cut-off amount smaller than that of the one optical filter in the cut-off band is provided on the optical reception surface of the light reception device 22.

For example, in comparison with the plano-convex lens 21 and the light reception device 22, quartz glass may be used for the plano-convex lens 21, and the semiconductor material may be used for the light reception device 22. Therefore, it may be understood that the plano-convex lens 21 may more easily secure the transparency of the input light than the light reception device 22.

Since the surface accuracy of the back surface of the plano-convex lens 21 may be easily secured by polishing or the like, it may be possible to easily improve adhesion to the dielectric multi-layer film used for the optical filter 31 or 32, for example, in comparison with the optical reception surface of the light reception device 22 using a semiconductor material.

If the surface accuracy of the dielectric multi-layer film and the adhesion to the dielectric multi-layer film are improved, since the remaining reflection amount which may occur in the boundary surface of the input light may be effectively suppressed, the amount of light loss caused by the dielectric multi-layer film may be reduced.

In addition, as a difference in thermal expansion coefficient between the dielectric multi-layer film and the material where the dielectric multi-layer film is provided is increased, the dielectric multi-layer film is easily deformed according to a change in temperature, and an amount of phase change in the dielectric multi-layer film is easily increased.

For this reason, as the difference in thermal expansion coefficient is increased, deviation from the characteristic expected easily occurs in the filter characteristic of the dielectric multi-layer film caused by the change in temperature, and the expected filter characteristic is difficult to obtain.

By comparing the thermal expansion coefficient of the quartz glass that is the material of the plano-convex lens 21 and the thermal expansion coefficient of the semiconductor that is the material of the light reception device 22, the thermal expansion coefficient of the quartz glass is in order of about 10⁻⁶, and the thermal expansion coefficient of the semiconductor is in order of about 10⁻⁵. The orders are different by one digit.

For this reason, with respect to the dielectric multi-layer film 31 provided to the plano-convex lens 21 and the dielectric multi-layer film 32 provided to the light reception device 22, the difference in thermal expansion coefficient in the former dielectric multi-layer film may be allowed to be smaller than that in the latter dielectric multi-layer film.

Therefore, it may be understood that the dielectric multi-layer film 31 provided to the plano-convex lens 21 may easily secure the expected filter characteristic than the dielectric multi-layer film 32 provided to the light reception device 22.

As described above, in terms of transparency, surface accuracy, and thermal expansion coefficient, among the optical filters 31 and 32, one optical filter having a cut-off amount larger than that of the other optical filter in the cut-off band is provided to the plano-convex lens 21, and the other optical filter having a cut-off amount smaller than that of the one optical filter is provided to the light reception device 22, so that the expected BPF characteristic may be easily implemented.

In other words, according to the respective expected cut-off amounts of short wavelength side and the long wavelength side of the reception wavelength λ2, the cut-off amounts of the cut-off bans of the long-pass optical filter and the short-pass optical filter and the application positions to the optical receiver 12 are used in a distinguishable manner. Therefore, the BPF characteristic according to the requirement may be easily implemented, so that the reception characteristic of the optical receiver 12 may be easily improved.

Even in the case where the expected cut-off amounts are not different in the cut-off bands of the short wavelength side and the long wavelength side with respect to the reception wavelength λ2 according to the system specification or the sometimes, due to a phenomenon called blue shift, a larger cut-off amount may be expected to occur in the cut-off band of the short wavelength side than in the cut-off band of the long wavelength side.

The “blue shift” is a phenomenon where the transmission characteristic is shifted to the short wavelength side. The phenomenon occurs when light is incident on the dielectric multi-layer film in a slanted direction to be shifted from the normal direction (in other words, the incident angle of 0 degree), so that the optical path length of the light propagating through the inner portion of the dielectric multi-layer film is lengthened.

For example, if there occurs a difference in installation angle between the optical filters 31 and 32 with respect to the optical receiver 12, a difference in incident angle of the light with respect to the dielectric multi-layer film occurs, so that the blue shift may occur. For this reason, it is expected that a larger cut-off amount may be needed for the cut-off band of the short wavelength side with respect to the reception wavelength λ2.

Therefore, for example, a long-pass (short cut) optical filter 31 may be provided to the plano-convex lens 21 where a larger cut-off amount may be easily secured, and a short-pass optical filter 32 may be provided to the light reception device 22.

In other words, if the long-pass optical filter 31 is provided to the plano-convex lens 21 and the short-pass optical filter 32 is provided to the light reception device 22, some degrees of the difference in incident angle of the light with respect to the dielectric multi-layer film may be allowed to occur. Therefore, it may be possible to mitigate the accuracy of installation of the optical filters 31 and 32 with respect to the optical receiver 12.

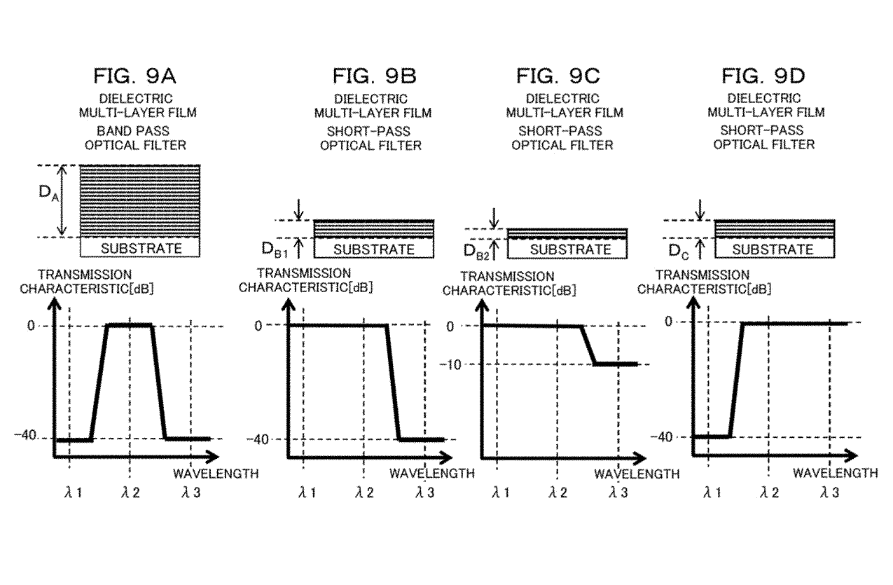

Next, a relationship between a filter characteristic and a thickness of the optical filter using a dielectric multi-layer film will be described with reference to FIGS. 9A to 9D.

FIG. 9A illustrates that the thickness of the dielectric multi-layer film formed on the substrate is D_{A} for obtaining a BPF characteristic. FIG. 9B illustrates that the thickness of the dielectric multi-layer film formed on the substrate is D_{B1} for obtaining the filter characteristic of the short-pass optical filter illustrated in FIG. 3B or 8.

FIG. 9C illustrates that the thickness of the dielectric multi-layer film formed on the substrate is D_{B2} for obtaining the filter characteristic of the short-pass optical filter illustrated in FIG. 7. FIG. 9D the thickness of the dielectric multi-layer film formed on the substrate is D_{C} for obtaining the filter characteristic of the long-pass optical filter illustrated in FIG. 3A or 7.

In addition, all of the “substrates” illustrated in FIGS. 9A to 9D are substrates made of a material transparent to incident light and may be glass substrates using quartz, for example. It is assumed that the filter characteristic of the band pass optical filter illustrated in FIG. 9A may be obtained by combining the short-pass optical filter illustrated in FIG. 9B and the long-pass optical filter illustrated in FIG. 9D.

In general, since the band pass optical filter has a complicated filter characteristic in comparison with the short-pass optical filter or the long-pass optical filter, the number of laminated layers tends to be increased.

In addition, in the band pass optical filter, as the pass band becomes a narrow band, and as the cut-off amount of the cut-off band becomes large, the number of laminated layers in the dielectric multi-layer film also tends to be increased.

For this reason, the band pass optical filter may be likely to have a total thickness of, for example, three times or more in comparison with the short-pass optical filter or the long-pass optical filter.

As a result, the yield may be easily decreased, or the cost may be easily increased.

Therefore, if a certain BPF characteristic is implemented by combining the short-pass optical filter and the long-pass optical filter where the dielectric multi-layer films are individually formed, it may be possible to further reduce the total thickness in comparison with the case where the BPF characteristic is implemented by one dielectric multi-layer film.

In addition, since the transmission characteristics of the short-pass optical filter and the long-pass optical filter are simpler than that of the band pass optical filter, the short-pass optical filter and the long-pass optical filter may be easily manufactured. Therefore, the decrease of the yield may be avoided or suppressed, and the cost may be reduced.

For example, if the BPF characteristic which is symmetric with respect to the reception wavelength λ2 illustrated in FIG. 4 is implemented by combining the filter characteristics illustrated in FIGS. 9B and 9D, D_{A}>(D_{B1}+D_{C}). Therefore, in comparison with the case of implementing the same BPF characteristic by one dielectric multi-layer film, it may be possible to reduce the total thickness.

As illustrated in FIGS. 9B and 9C, even in the case of the same short-pass optical filters, as the cut-off amount obtained in the cut-off band is decreased, the number of films in the dielectric multi-layer film may be decreased. In the example of FIGS. 9B and 9C, D_{B1}>D_{B2}. In addition, even in the case of the long-pass optical filter, as the cut-off amount obtained in the cut-off band is decreased, the number of films in the dielectric multi-layer film may be decreased.

Therefore, for example, if an asymmetric BPF characteristic with respect to the reception wavelength λ2 illustrated in FIG. 7 is implemented by combing the filter characteristics illustrated in FIGS. 9C and 9D is implemented, D_{A}>(D_{B2}+D_{C}), and (D_{B2}+D_{C})<(D_{B1}+D_{C}).

Therefore, in comparison with the case where the above-described symmetric BPF characteristic is implemented, it may be possible to further reduce the total thickness. The same effect may be obtained even in the case where an asymmetric BPF characteristic illustrated in FIG. 8 is implemented.

In the band pass optical filter, in principle, the transmission characteristic has symmetry between the short wavelength side and the long wavelength side, and thus, it is not practical that the filter characteristic where the cut-off amounts are different between the short wavelength side and the long wavelength side is implemented by one band pass optical filter.

In other words, one band pass optical filter has to be designed and manufactured in accordance with the requirement of a large cut-off amount. For this reason, since the thickness of the dielectric multi-layer film is excessively increased, the yield may be easily decreased, or the cost may be easily increased.

Therefore, as described above, by separating the high pass optical filter and the short-pass optical filter and by forming the dielectric multi-layer film having a thickness according to the expected cut-off amount in each cut-off band, it may be possible to avoid or suppress the deterioration in yield or the high cost caused by the excessive thickness.

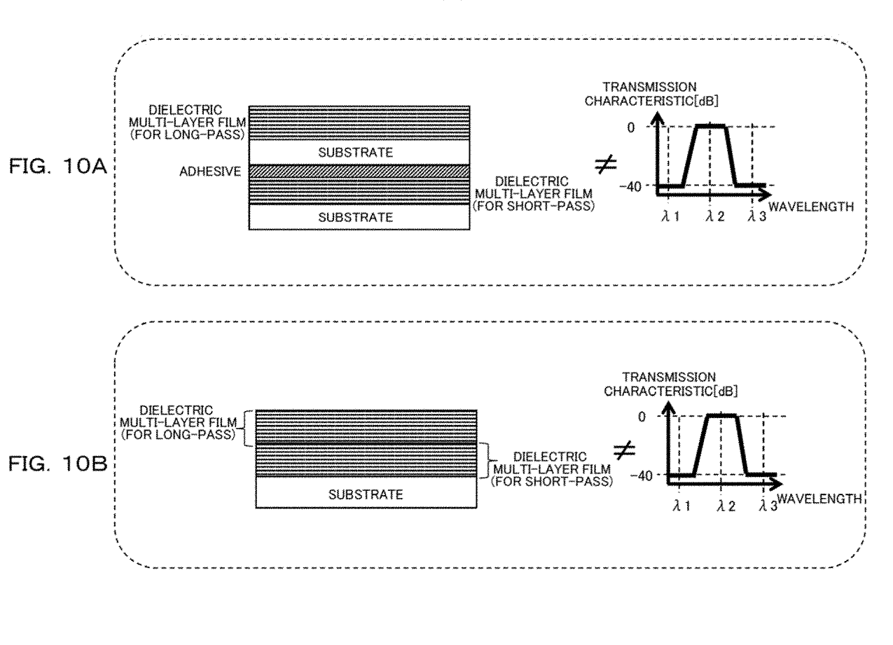

In addition, as illustrated in FIG. 10A, the expected BPF characteristic is not obtainable by adhering the dielectric multi-layer film for short-pass optical filter and the long-pass optical filter separately formed on the substrate by using adhesive.

As illustrated in FIG. 10B, the expected BPF characteristic is not obtainable by laminating the dielectric multi-layer film for the short-pass optical filter and the dielectric multi-layer film for the long-pass optical filter on the substrate, for example, through deposition instead of using the adhesive.

This is because, in any cases of FIGS. 10A and 10B, new light interference occurs in the boundary surface between the dielectric multi-layer film and the adhesive or in the boundary surface between the dielectric multi-layer film for the short-pass optical filter and the dielectric multi-layer film for the long-pass optical filter.

Since the optical filter using the dielectric multi-layer film implements the filter characteristic by using light interference in the dielectric multi-layer film, if new light interference occurs, the filter characteristic is also changed.

Therefore, although the expected filter characteristics may be implemented separately by the dielectric multi-layer film for the short-pass optical filter and the dielectric multi-layer film for the long-pass optical filter, both of the dielectric multi-layer films are laminated by adhesive or deposition, the individual filter characteristics are not maintained. Therefore, the expected BPF characteristic is not obtainable.

If the expected BPF characteristic is not obtained, the reception characteristic of the optical receiver 12 in the optical transceiver 1 does not satisfy the expected characteristic.

In the case of using the adhesive illustrated in FIG. 10A, in the relationship with respect to the thermal expansion ratio or the refractive index of the adhesive, the filter characteristics which may be implemented separately for the short-pass optical filter and the long-pass optical filter may be changed. If the adhesive is used, the reliability of the strength as an optical part is also deteriorated.

(Shape of Plano-Convex Lens)

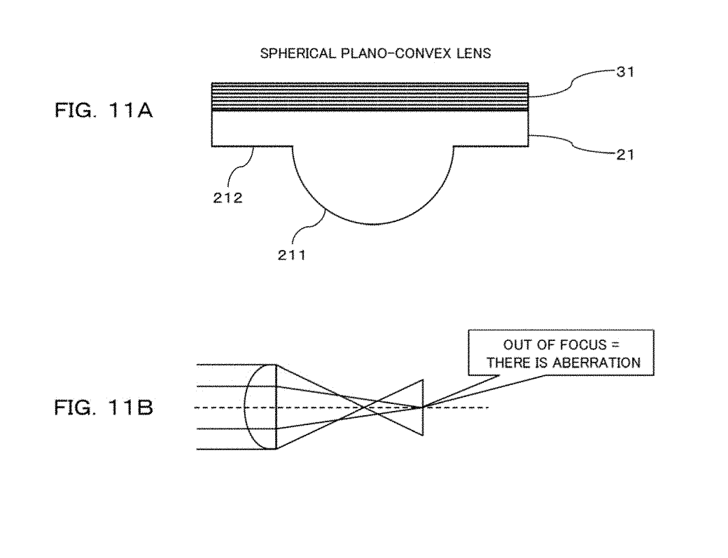

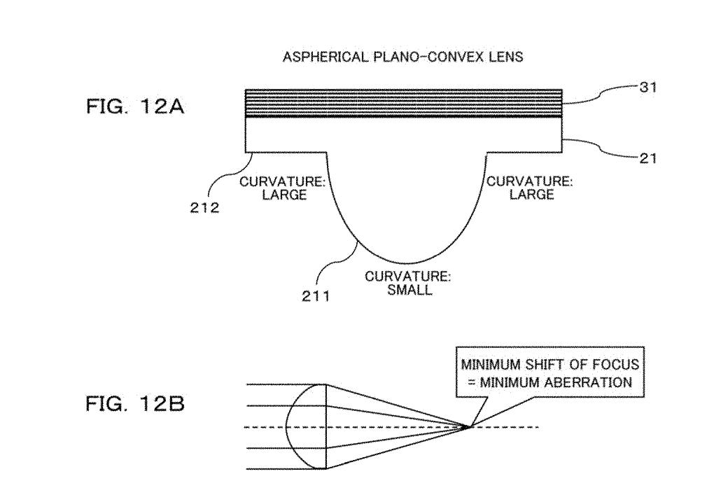

Next, an example of the shape of the plano-convex lens 21 will be described with reference to FIGS. 11 and 12. FIG. 11A is a schematic side view illustrating that the convex lens portion 211 of the plano-convex lens 21 is a spherical shape. FIG. 11B is a schematic side view illustrating a light collection path by the plano-convex lens 21 illustrated in FIG. 11A.

FIG. 12A is a schematic side view illustrating that the convex lens portion 211 of the plano-convex lens 21 is an aspherical shape. FIG. 12B is a schematic side view illustrating a light collection path by the plano-convex lens 21 illustrated in FIG. 12A. In addition, the “aspherical” shape has a curve which is neither a spherical surface nor a plane surface, for example.

As illustrated in FIG. 11A, a plano-convex lens of which shape of the convex lens portion 211 is a spherical shape may be applied to the plano-convex lens 21, and as illustrated in FIG. 11B, a plano-convex lens of which shape of the convex lens portion 211 is an aspherical shape may be applied to the plano-convex lens.

In comparison with a ball lens, the plano-convex lens 21 has a weak refraction effect (sometimes, referred to as a “refraction power”) (for example, about ½). For this reason, in a simple spherical shape illustrated in FIG. 11A, the lens aberration is large in comparison with the ball lens having the same focal length, and the position of the focus is easily deviated from the optical reception surface as illustrated in FIG. 11B.

In contrast, as illustrated in FIG. 12A, if the plano-convex lens where the convex lens portion 211 is formed in aspherical shape is applied to the plano-convex lens 21, the lens aberration is suppressed, and thus, the position of the focus may be easily aligned with the expected optical reception surface. Therefore, it may be possible to improve the reception characteristic of the optical receiver 12.

In addition, the aspherical plano-convex lens 21 may be manufactured by using “glass mold”, for example. The aspherical plano-convex lens 21 may be manufactured by injecting a glass material referred to as a preform into an aspherical mold, heating the mold to soften the glass material, and after that, pressing, for example. The aspherical plano-convex lens 21 may be more easily manufactured by using the “glass mold” than by polishing the glass material.

As a non-limitative example, as schematically illustrated in FIG. 12A, the aspherical convex lens portion 211 may has a shape where the curvature of the peripheral portion is larger than that of the central portion of the convex lens portion. For example, the curvature of the central portion of the convex lens portion 211 and the curvature of the peripheral portion of the convex lens portion may be determined on the basis of one or more of parameters exemplified as follows.

(a) A distance from an end portion (stub end) of the stub 212 of the convex lens portion 211 to the convex lens portion 211

(b) A distance from the convex lens portion 211 to the light reception device 22

(c) An area of the optical reception surface of the light reception device 22

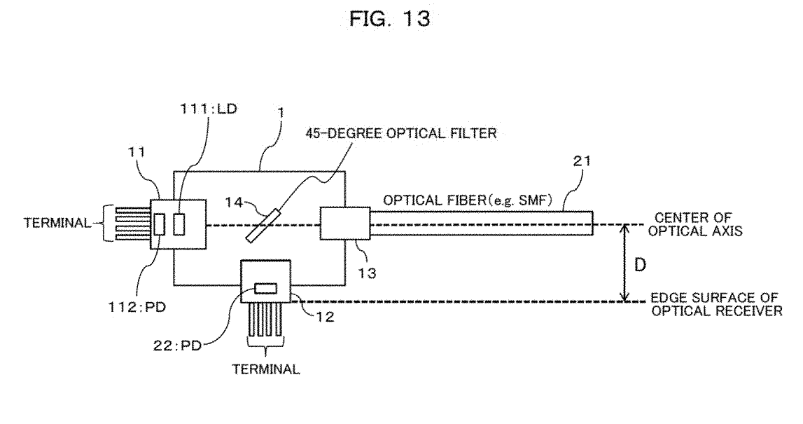

According to the above-described configuration of the optical receiver 12, as illustrated in FIG. 13, it may be possible to reduce a distance D between an optical axis (in other words, the center of the optical axis of the optical fiber connector 13 and the optical fiber 21) of the transmission light of the optical transmitter 11 and an edge surface at the side apposite to the optical reception surface of the optical receiver 12. If the distance D may be reduced, it is possible to reduce the size of the optical transceiver 1 in the width direction.

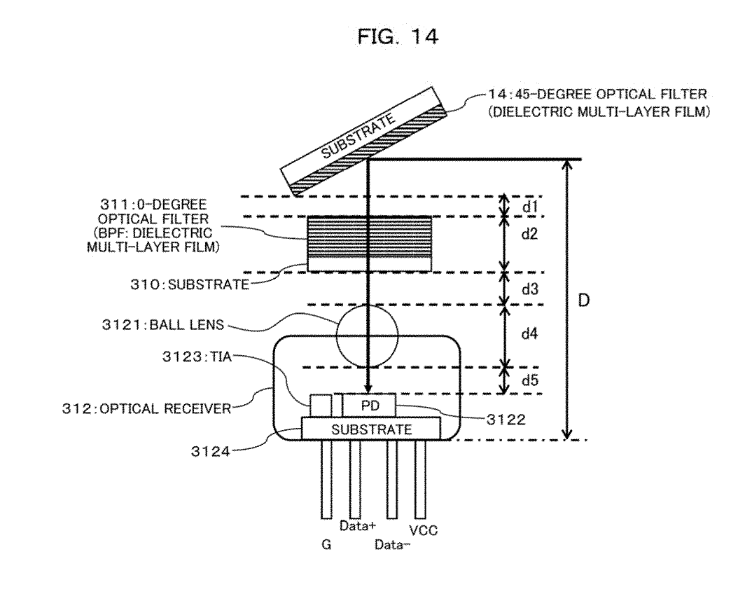

The reason why the distance D may be reduced will be described with reference to Comparative Example illustrated in FIG. 14. FIG. 14 is a diagram illustrating an example of a configuration of a reception system of the optical transceiver as Comparative Example of the above-described embodiment.

In the reception system illustrated in FIG. 14, a 0-degree optical filter 311 and an optical receiver 312 including a ball lens 3121 are arranged to be spatially separated on an optical path of light reflected by a 45-degree optical filter 14.

The 0-degree optical filter 311 is a dielectric multi-layer film formed on a glass substrate 310. For example, the dielectric multi-layer film 311 has a structure and a BPF characteristic illustrated in FIG. 9A.

Therefore, the 0-degree optical filter 311 transmits the light having the reception wavelength λ2 among the light beams which are incident from the 45-degree optical filter 14 and reflects and block the wavelength (for example, λ1 and λ3) other than the reception wavelength λ2.

The light having the reception wavelength λ2 which passes through the 0-degree optical filter 311 is incident on the ball lens 3121 of the optical receiver 312, and the light is collected on the optical reception surface of the PD 3122 by the ball lens 3121. The PD 3122 may be provided on the substrate 3124, and a TIA 3123 may be provided on the substrate 3124.

The distances D illustrated in FIG. 13 are defined depending on, for example, the following distances (or lengths) d1 to d5 in FIG. 14.

d1: a distance between the 45-degree optical filter 14 and the 0-degree optical filter 311

d2: a total thickness of the 0-degree optical filter 311 and the substrate 310

d3: a distance between the substrate 310 of the 0-degree optical filter 311 and the ball lens 3121

d4: a diameter of the ball lens 3121

d5: a distance between the ball lens 3121 and the PD 3122

If the distance d1 is allowed to be so small that the 45-degree optical filter 14 and the 0-degree optical filter 311 are in contact with each other, due to stress distortion, one or both of the optical filters 14 and 311 may be easily deteriorated according to aging. For example, cracks are likely to occur in one or both of the optical filters 14 and 311, and the filter characteristic or the reliability may be deteriorated.

In the 0-degree optical filter 311 having the BPF characteristic, as described in FIG. 9A to FIG. 9D, since it is difficult to increase the number of laminated layers in the dielectric multi-layer film, so that there is a limitation in reduction of the distance d2. In addition, if the number of laminated layers in the dielectric multi-layer film is increased, the characteristic or the production yield may be easily deteriorated.

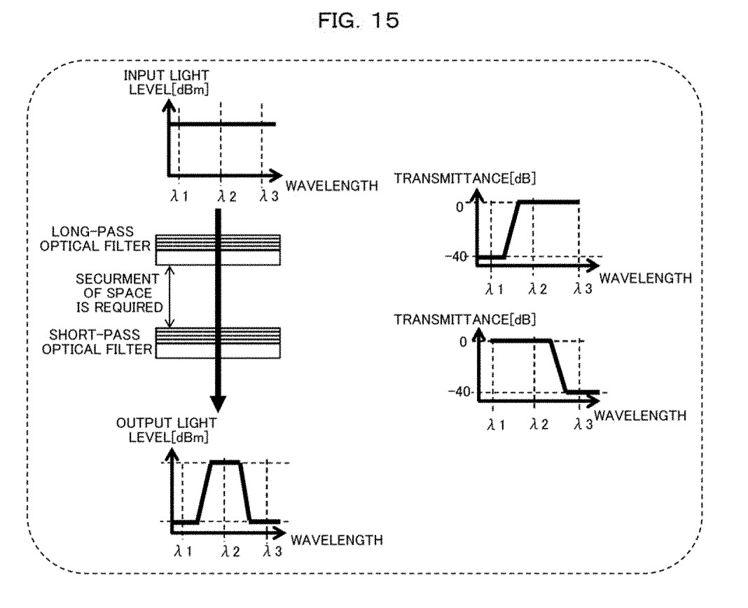

As illustrated in FIG. 15, although the BPF characteristic equivalent to the 0-degree optical filter 311 is implemented by combining separate parts of the short-pass optical filter and the long-pass optical filter, only the number of parts where are arranged to be separated spatially is increased. Therefore, the distance d2 is not reduced.

Since there is a limitation in reduction of the distance d2, there is also a limitation in reduction of the distance d3. As the distance d3 is allowed to be too small, if the substrate 310 of the 0-degree optical filter 311 and the ball lens 3121 are in contact with each other, due to stress distortion, one or both of the optical filter and the ball lens may be easily deteriorated according to aging.

For example, cracks are likely to occur in one or both of the 0-degree optical filter 311 (and/or the substrate 310) and the ball lens 3121, the filter characteristic or the reliability may be deteriorated.

Since the light output from the ball lens 3121 is focused on the optical reception surface of the PD 3122, the distances d4 and d5 depend on the focal length of the ball lens 3121, and thus, there is a limitation in reduction.

As described above, in Comparative Example of FIG. 14, since there is a limitation in reduction of the distances d1 to d5, there is also a limitation in reduction of the distance D, and strict optical alignment at plural positions is needed. For this reason, it is difficult to miniaturize the SFP optical transceiver in the width direction, and the production yield is deteriorated so that the cost is likely to be high.

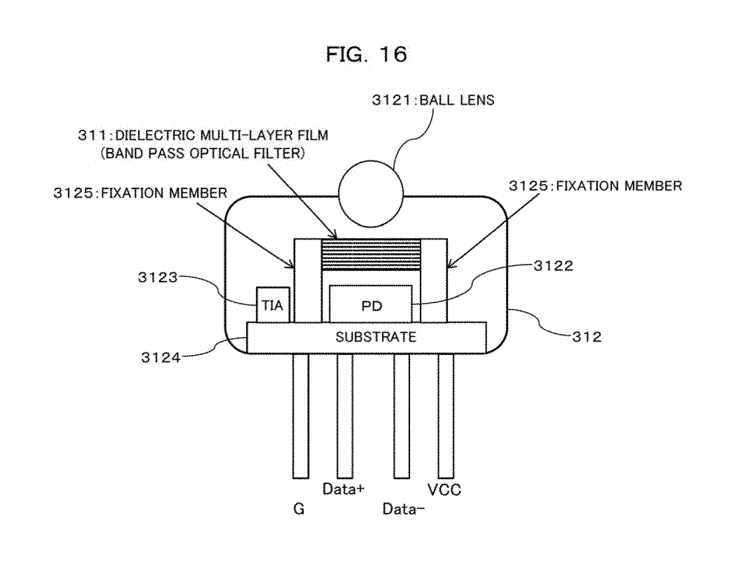

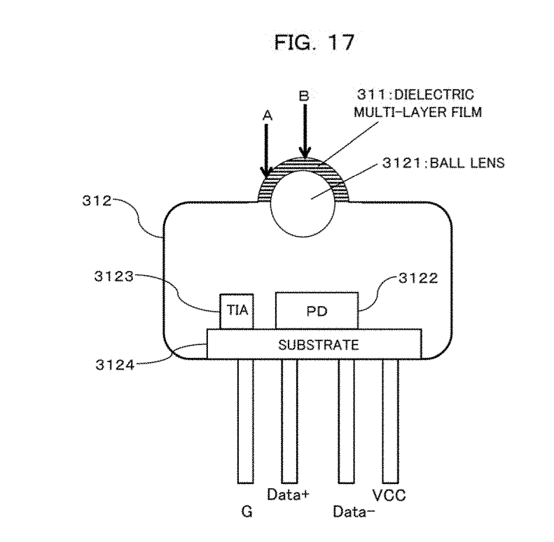

As a modified example of Comparative Example of FIG. 14, a configuration illustrated in FIG. 16 or 17 is also considered. FIG. 16 illustrates an example where, in an inner portion of the optical receiver 312, a band pass optical filter configured with a dielectric multi-layer film corresponding to the 0-degree optical filter 311 is provided between the ball lens 3121 and the PD 3122.

In the example of FIG. 16, one or more fixation members 3125 are provided on the substrate 3124 in order to support and fix the 0-degree optical filter 311 in a space between the ball lens 3121 and the PD 3122.

In this case, in order to assemble the fixation member 3125 and the dielectric multi-layer film 311 in the inner portion of the optical receiver 312, a space where an assembly jig is inserted into the inner portion of the optical receiver 312 is needed, and assembly tolerance also occurs. If the assembly tolerance between the inner parts, the insertion space for the assembly jig, and the like are considered, in the example of the configuration of FIG. 16, it may be difficult to reduce the distance d5 of FIG. 14.

Alternatively, as illustrated in FIG. 17, it may be considered that the fixation member 3125 may be allowed to be unnecessary by forming the dielectric multi-layer film corresponding to the 0-degree optical filter 311 which is a band pass optical filter on the hemispherical surface of the ball lens 3121 on which the light is incident, for example, through deposition.

However, as indicated by arrows A and B in FIG. 17, if incident positions of light with respect to the dielectric multi-layer film 311 are different, the thicknesses of the portions of the dielectric multi-layer film 311 where the light propagates are different. For this reason, the expected BPF characteristic (in other words, the BPF characteristic as designed) is not obtainable. Therefore, the reception characteristic as the optical receiver 312 is not the expected characteristic. For example, the characteristic does not fall into a range where light loss, crosstalk, or the like is allowable.

In Comparative Example illustrated in FIGS. 14 to 17, since it is possible that a 0-degree optical filter 311 (and a substrate 310) is not provided between the 45-degree optical filter 14 and the optical receiver 12 amplification transistor the configuration of the embodiment illustrated in FIG. 2, for example, distances d2 and d3 of FIG. 14 may be omitted.

In other words, since it is possible that the band pass optical filter 311 which is likely to thicken the dielectric multi-layer film is not provided to the inner portion and the outer portion of the optical receiver 12, it may be possible to miniaturize the optical receiver 12 and it may be possible to miniaturize the optical transceiver 1 in the width direction.

Since the band pass optical filter 311 is unnecessary, the number of optical alignment positions in the inner space of the optical transceiver 1 may be reduced. Therefore, the production yield of the optical transceiver 1 may be improved, and furthermore, the cost of the optical transceiver 1 may be reduced.

In the example of the configuration of FIG. 2, the filter characteristic of the band pass optical filter 311 is implemented by combining the first optical filter 31 provided to the back surface of the plano-convex lens 21 and the second optical filter 32 provided to the optical reception surface of the light reception device 22.

As described above, the first optical filter 31 is one of the long-pass optical filter and the short-pass optical filter, and the second optical filter 32 is the other of the long-pass optical filter and the short-pass optical filter.

Both of the long-pass optical filter and the short-pass optical filter are examples of an SSB filter, and in comparison with the band pass optical filter, the number of laminated layers in the dielectric multi-layer film may be small, so that the optical filters may be easily manufactured.

Therefore, it may be possible to suppress the increase in size of the optical receiver 12 by providing the two optical filters 31 and 32 to the optical receiver 12. In addition, since the characteristics or the production yield of the optical filters 31 and 32 may be improved, the reception characteristic or the yield of the optical receiver 12 may also be improved.

In addition, since the expected BPF characteristic may be easily secured by providing the optical filter having a smaller cut-off amount in the cut-off band among the long-pass optical filter and the short-pass optical filter on the optical reception surface of the light reception device 22, even in the case of the reception characteristic of the optical receiver 12, the expected characteristic may be easily secured.

In addition, since the plano-convex lens 21 is provided to the optical receiver 12 instead of the ball lens 3121 and the first optical filter 31 which is a dielectric multi-layer film by using the plano-convex lens 21 as the substrate is provided to the back surface of the plano-convex lens 21, for example, the distance d4 of FIG. 14 may be reduced.

Therefore, the distance between the 45-degree optical filter 14 and the optical receiver 12 may be easily reduced as much as possible. In addition, in the inner space of the optical transceiver 1 in the width direction, the optical alignment of the optical receiver 12 with respect to the 45-degree optical filter 14 may be easily performed.

Hence, the distance D of FIG. 13 may be reduced as much as possible, the optical transceiver 1 may be miniaturized in the width direction, and the production yield may also be improved. Therefore, it may be possible to reduce the cost of the optical transceiver 1.

In addition, in the case where the size of the optical transceiver 1 in the width direction is not changed or in the case where the optical transceiver 1 is not miniaturized as much as possible, an empty space having a width according to the reduction of the distance D may be provided to the with-directional inner space of the optical transceiver 1 in the longitudinal direction of the optical transceiver 1.

Additional parts may be provided in the empty space. A non-limitative example of the additional part is a light pipe for a light-emitting diode (LED). For example, in some cases, the LED may be provided on a side surface of a case of the optical transceiver 1 so that an operation state of the optical transceiver 1 may be visually recognized from the outside. A light pipe for the LED provided on the side surface of the case may be provided in the empty space generated according to the reduction of the distance D.

(Method of Manufacturing Plano-Convex Lens Attached with Optical Filter)

In the example of configuration illustrated in FIG. 2, although the dielectric multi-layer film as the optical filter 31 may be formed on the back surfaces of the individual plano-convex lenses 21 as individual parts through deposition or the like, it is preferable in terms of mass productivity that the dielectric multi-layer films may be integrally formed on the back surface of the plano-convex lens array through deposition or the like.

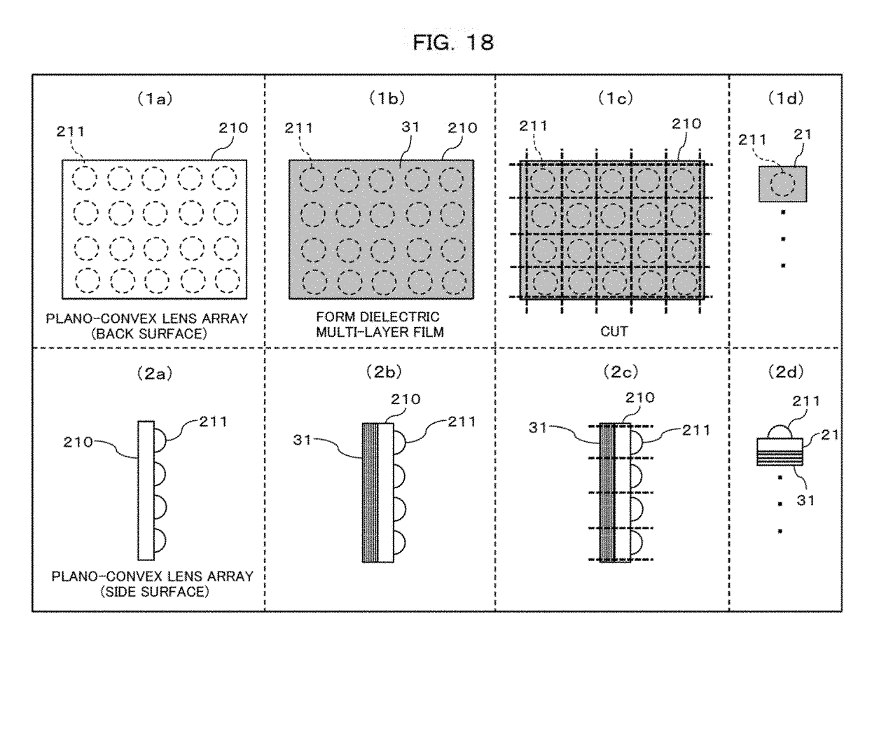

FIG. 18 illustrates an example of a method of manufacturing the plano-convex lens 21 attached with the optical filter 31. (1a) to (1d) illustrated in the upper portion of FIG. 18 are schematic plan views illustrating processes of manufacturing the plano-convex lens 21, and (2a) to (2d) illustrated in the lower portion of FIG. 18 are schematic side views corresponding to (1a) to (1d) of FIG. 18, respectively.

As illustrated in (1a) and (1b) of FIG. 18, first, a plano-convex lens array 210 having a plurality of convex lens portions 211 in an array shape is formed. For example, glass mold may be applied to formation of the plano-convex lens array 210.

For example, the plano-convex lens array 210 having a plurality of the convex lens portions 211 may be manufactured by injecting a preform (glass material) into a mold having concave portions corresponding to a plurality of the convex lens portions 211 in an array shape, heating the mold to soften the glass material, and after that, pressing.

Next, as illustrated in (1b) and (2b) of FIG. 18, the dielectric multi-layer film as the optical filter 31 is integrally formed through deposition or the like on the entire back surface in the side opposite to the side where the convex lens portion 211 of the plano-convex lens array 210 is formed.

Before the formation of the dielectric multi-layer film 31, the entire back surface of the plano-convex lens array 210 may be polished. The surface accuracy of the back surface of the plano-convex lens array 210 may be improved by the polishing.

As a non-limitative example of the material of the dielectric multi-layer film 31, there may be exemplified silicon dioxide (SiO₂), aluminum oxide (Al₂O₃), tantalum pentoxide (Ta₂O₅), titanium dioxide (TiO₂), zirconium dioxide (ZrO₂), niobium pentoxide (Nb₂O₅), and the like.

These materials may be classified as follows, for example, according to refractive index.

Low refractive index (about 1.5): SiO₂

Intermediate refractive index (about 1.76): Al₂O₃

High refractive index (about 2.2): Ta₂O₅, TiO₂, ZrO₂, Nb₂O₅

The dielectric multi-layer film may be formed by alternately laminating the dielectric films made of materials having different refractive indexes according to the needed filter characteristic, for example, through deposition or the like. For example, film formation techniques such as ion assisted deposition (IAD), ion beam sputtering (IBS) film formation, vacuum deposition, and digital sputtering (DS) film formation may be applied to deposition of the dielectric film. The vacuum deposition may include a film formation process using an electron beam (EB) method, a resistive heating method, or the like.

When the total thickness (d) of the dielectric multi-layer film 31 is adjusted so that the optical path length (refractive index n×thickness d) becomes λ/4 (λ is a wavelength of input light), the light beams which are reflected by the layers are in phase to be strengthened, and the light beams which are reflected multiple times by the layers and propagate in the transmission direction are canceled out. Therefore, it may be possible to minimize the reflectance.

After the dielectric multi-layer film 31 is formed on the back surface of the plano-convex lens array 210, as illustrated in (1c), (1d), (2c), and (2d) of FIG. 18, the individual plano-convex lenses 21 are cut out from the plano-convex lens array 210 by using a substrate division technique. As a non-limitative example of the substrate division technique, there may be exemplified router division, dicing division, pressing division, and the like.

After the dielectric multi-layer film 31 is formed on the back surface of the plano-convex lens array 210, by cutting out the individual plano-convex lenses 21 from the plano-convex lens array 210, the plano-convex lenses 21 attached with the optical filter 31 may be mass-produced. Therefore, it may be possible to reduce the cost of the plano-convex lenses 21 attached with the optical filters 31.

(Method of Manufacturing Light Reception Device Attached with Optical Filter)

In the example of configuration illustrated in FIG. 2, although the dielectric multi-layer film as the optical filter 32 may be formed on the optical reception surfaces of the individual light reception devices 22 as individual parts, it is preferable in terms of mass productivity that the dielectric multi-layer films may be may be integrally formed on the back surface of the light-reception semiconductor wafer through deposition or the like.

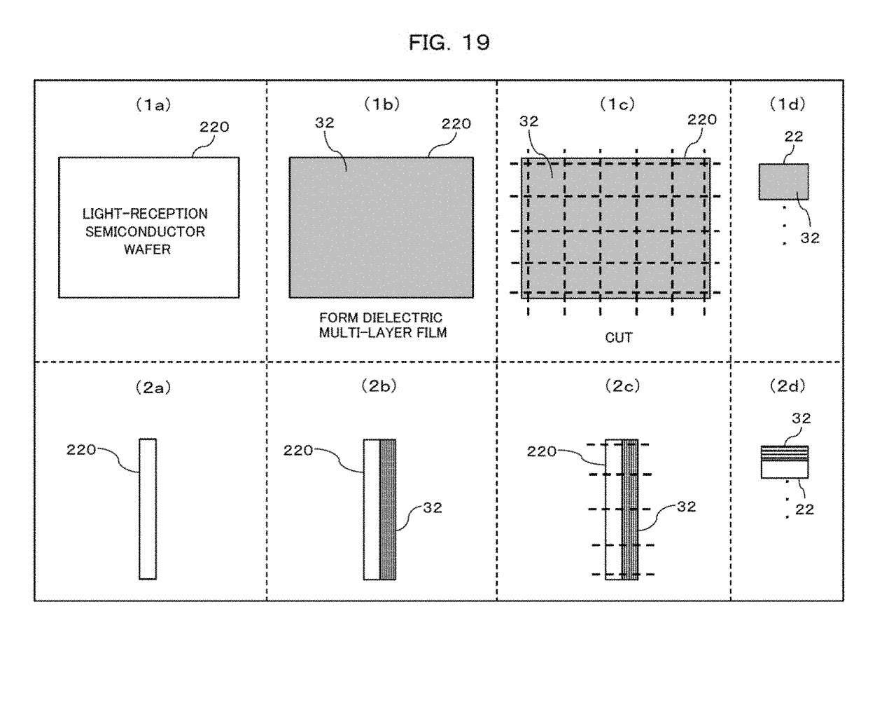

FIG. 19 illustrates an example of a method of manufacturing the light reception device 22 attached with the optical filter 32. (1a) to (1d) illustrated in the upper portion of FIG. 19 are schematic plan views illustrating processes of manufacturing the light reception device 22, and (2a) to (2d) illustrated in the lower portion of FIG. 19 are schematic side views corresponding to (1a) to (1d) of FIG. 19, respectively.

As illustrated in (1a), (1b), (2a), and (2b) of FIG. 19, the dielectric multi-layer film as the optical filter 32 is integrally formed on the entire optical reception surface of a light-reception semiconductor wafer 220 which is made of a compound semiconductor material, for example, through deposition or the like.

After that, as illustrated in (1c), (1d), (2c), and (2d) of FIG. 19, the individual light reception devices 22 are cut out from the light-reception semiconductor wafer 220 by using the above-described substrate division technique.

After the dielectric multi-layer film 32 is formed on the optical reception surface of the light-reception semiconductor wafer 220, by cutting out the individual light reception devices 22 from the light-reception semiconductor wafer 220, the light reception devices 22 attached with the optical filters 32 may be mass-produced. Therefore, it may be possible to reduce the cost of the light reception devices 22 attached with the optical filters 32.

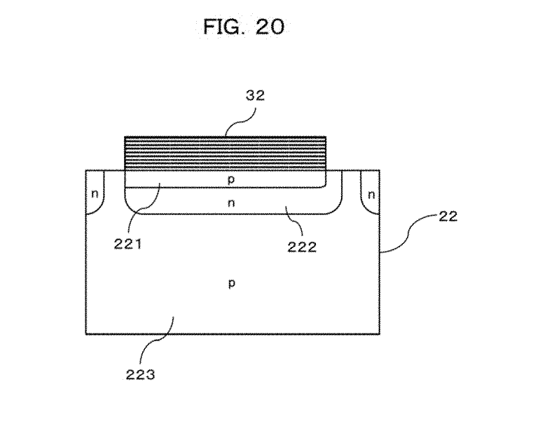

FIG. 20 illustrates a schematic side cross-sectional view of the example of configuration of the light reception device 22 attached with the optical filter 32.

For example, as illustrated in FIG. 20, the light reception device 22 may also be a compound semiconductor device having a so-called p-n-p junction laminate structure where a p-type semiconductor layer 221, an n-type semiconductor layer 222, and a p-type semiconductor layer 223 are laminated. However, not limited to the p-n-p junction, the light reception device 22 may have another laminate structure of, for example, n-p-n junction or the like.

As illustrated in FIG. 20, the dielectric multi-layer film as the optical filter 32 may be formed on the surface of the uppermost-layered p-type semiconductor layer 221 corresponding to the optical reception surface of the light reception device 22. In addition, it may be understood that the light-reception semiconductor wafer 220 described above in FIG. 19 may have such a laminate structure of the compound semiconductor as illustrated in FIG. 20. In other words, the manufacturing method illustrated in FIG. 19 may be applied to the manufacturing of the light reception device 22 attached with the optical filter 32 illustrated in FIG. 20.

(Modified Example 1 of Light Reception Device Attached with Optical Filter)

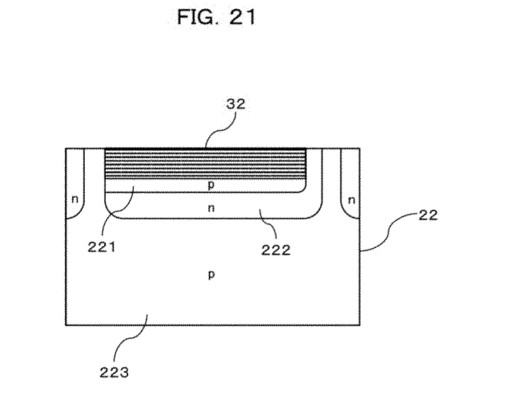

A light reception device 22 illustrated in FIG. 20 is an example where a dielectric multi-layer film 32 is formed separately from the optical reception surface of the light reception device 22. However, as illustrated in FIG. 21, the dielectric multi-layer film 32 may be formed integrally with a semiconductor layer 221 as a portion of a laminate structure of a compound semiconductor device.

For example, in the integral formation of the dielectric multi-layer film 32, a technique of distributed Bragg reflector (DBR) reflection used for a vertical-cavity surface-emitting laser (VCSEL) may be used.

For example, by alternately growing and laminating crystals of compound semiconductor materials having different refractive indexes on the semiconductor layer 221, an optical filter functional portion equivalent to the dielectric multi-layer film 32 may be formed. As a material of the compound semiconductor layer, a semiconductor material having as low light absorbance as possible may be applied so as to reduce light loss as the light reception device 22.

As a non-limitative example of the materials of the compound semiconductor layers having the light absorbance within an allowable range and the different refractive indexes, there may be exemplified gallium arsenide (GaAS) and aluminum arsenide (AlAs).

Since the crystal growing may be performed to form a film in low temperature environment in comparison with the temperature environment of the deposition, it may be understood that it may be difficult to exert thermal damage to the light reception device 22 using a semiconductor compound material.

(Modified Example 2 of Light Reception Device Attached with Optical Filter)

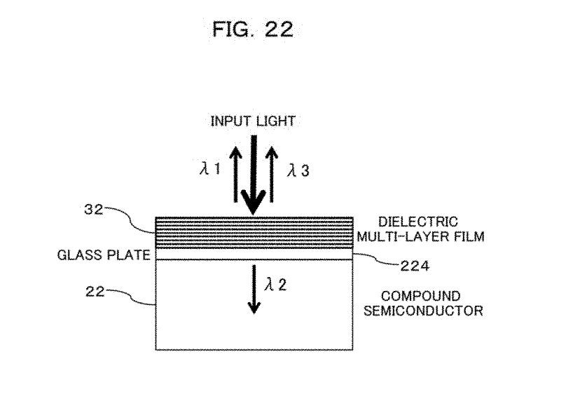

As illustrated in FIG. 22, the dielectric multi-layer film as the optical filter 32 may be provided on the optical reception surface of the light reception device 22 with a glass plate 224 interposed therebetween.

The dielectric multi-layer film 32 may be formed on one surface of the glass plate 224 through deposition or the like.

The other surface of the glass plate 224 of which one surface is formed with the dielectric multi-layer film 32 may be attached on the optical reception surface of the light reception device 22. For example, adhesive may be used for the attachment. The adhesive may be coated on one or both of the optical reception surface of the light reception device 22 and the other surface of the glass plate 224 while avoiding the optical path of the light which is input on the optical reception surface of the light reception device 22.

According to Modified Example 2, since the dielectric multi-layer film 32 is formed on the glass plate 224, in comparison with the case where the dielectric multi-layer film 32 is formed in the light reception device 22 using a semiconductor compound material, it may be possible to further decrease a difference in thermal expansion coefficient between the dielectric multi-layer film and the glass plate, so that it may be possible to improve the adhesion. In addition, thermal damage is not exerted to the light reception device 22 using the semiconductor compound material.

(Others)

In the above-described embodiment, although the plano-convex lens is exemplified as the light collection device 21, the light collection device 21 may have at least a plane surface and a lens portion provided on the side opposite to the plane surface. A dielectric multi-layer film having a function as the optical filter 31 may be formed on the plane surface of the light collection device 21.

All examples and conditional language provided herein are intended for pedagogical purposes to aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiment(s) of the present invention have been described in detail, it should be understood that the various changes, substitutions, and alterations could be made hereto without departing from the spirit and scope of the invention.

What is claimed is:

1. An optical receiver comprising:
a light collection device;
a light reception device arranged to receive output light of the light collection device;
a first optical filter provided on an optical incident surface of the light collection device; and
a second optical filter provided on an optical reception surface of the light reception device,
wherein one of the first and second optical filters is a long-pass optical filter and the other one of the first and second optical filters is a short-pass optical filter.

2. The optical receiver according to claim 1, wherein the first optical filter is a first dielectric multi-layer film, the light collection device is a plano-convex lens with a plane surface serving as the optical incident surface, and the first dielectric multi-layer film is formed on the plane surface of the plano-convex lens.

3. The optical receiver according to claim 1,
wherein the long-pass optical filter and the short-pass optical filter have different cut-off amounts in respective cut-off bands,
wherein, among the long-pass optical filter and the short-pass optical filter, one optical filter having a cut-off amount larger than that of the other optical filter is provided on the optical incident surface of the light collection device, and
wherein, among the long-pass optical filter and the short-pass optical filter, the other optical filter having a cut-off amount smaller than that of the one optical filter is provided on the optical reception surface of the light reception device.

4. The optical receiver according to claim 1, wherein the second optical filter is a second dielectric multi-layer film, and the second dielectric multi-layer film is formed on the optical reception surface of the light reception device.

5. The optical receiver according to claim 2, wherein a convex lens portion of the plano-convex lens has an aspherical shape of which curvature of a peripheral portion is larger than that of a central portion.

6. The optical receiver according to claim 4, wherein the light reception device is a compound semiconductor device which includes a laminate structure of compound semiconductor materials having different indexes as the second dielectric multi-layer film in a portion of the compound semiconductor device.

7. An optical transceiver comprising:
an optical transmitter configured to transmit first light;
a wavelength separation device configured to transmit the first light to an optical fiber transmission line and to reflect second light toward a direction intersecting with a direction in which the first light propagates, the second light having a wavelength different from that of the first light and propagating in the optical fiber transmission line in a direction reverse to the direction in which the first light propagates; and
an optical receiver configured to receive the second light reflected by the wavelength separation device,
wherein the optical receiver includes:
a light collection device on which the second light is incident;
a light reception device arranged to receive output light of the light collection device;
a first optical filter provided on an optical incident surface of the light collection device; and
a second optical filter provided on an optical reception surface of the light reception device,
wherein one of the first and second optical filters is a long-pass optical filter and the other one of the first and second optical filters is a short-pass optical filter.
